(19) United States
(12) Patent Application Publication
(10) Pub. No.: US 2009/0178510 A1
(43) Pub. Date: Jul. 16, 2009

(54) SYSTEM AND METHOD FOR INTEGRATED FOOTBOARD AND BRAKE ACTUATION MEMBER

(76) Inventors: Paul R. Whitlock, Midvale, UT (US); Robert W. Cowden, Spanish Fork, UT (US)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 12/351,973

(22) Filed: Jan. 12, 2009

Related U.S. Application Data
(63) Continuation of application No. 61/020,224, filed on Jan. 10, 2008.

(51) Int. Cl. G05G 1/30

(52) U.S. Cl. 74/561; 74/512

(57) ABSTRACT

A brake actuation assembly for a motorcycle comprising a footboard with an integrated brake system is provided herein. The present system provides a footboard, that when pivoted around a pivot point, actuates the internal brake mechanism. A rider is able to apply the brakes in a more comfortable and efficient manner with the pivoting footboard assembly than with the traditional lever arm of a motorcycle. A pivot pin configured to support the extra weight and potential torques is provided that replaces the existing brake pin. Additionally, a novel brake actuator member provides compatibility with the pivoting footboard and traditional brake mechanisms of motorcycles.

### RELATED APPLICATIONS

This application claims the benefit under 35 U.S.C. § 119(e) of U.S. Provisional Patent Application No. 61/020,224 filed Jan. 10, 2008 which is titled “SYSTEM AND METHOD FOR INTEGRATED FOOTBOARD AND BRAKE ACTUATION MEMBER”. The above-mentioned application is incorporated herein by reference in its entirety.

### TECHNICAL FIELD

The present apparatus and method relate to a brake system for motorcycles. In particular, the present apparatus and method relate to a foot brake for use with motorcycles having footboards upon which an operator may rest his/her feet while riding.

### BACKGROUND

Cruiser and touring style motorcycles are increasing in popularity and the demand for comfort while riding is ever present. It is generally conceded that motorcycles having footboards provide riders with a more comfortable resting place for their feet than do conventional foot pegs. Naturally, the number of motorcycles having footboards rather than foot pegs has increased rapidly. Footboards enable riders to place their feet on a small board or platform on each side of the motorcycle while riding, thereby increasing the foot support, and consequently the comfort of the ride.

Footboards have several advantages over foot pegs, especially for long distance riding. Footboards allow the rider's foot to rest fully supported on a flat surface, rather than resting on a foot peg that provides minimal support and a localized pressure point. Those familiar with motorcycle touring will appreciate that foot pegs provide little support for the lower leg, and after long rides can often result in sore muscles in the foot and calf.

One shortcoming of traditional footboards is the accessibility of the brake. For example, FIG. 1A illustrates a side view of a rider (100) on a motorcycle (110). The rider's foot (120) is resting on the footboard (130) near the bottom of the motorcycle (110). The brake lever assembly (140) includes a brake lever (144) that extends at an angle and terminates above the footboard (130).

FIGS. 1B through 1D illustrate close-up views of the exemplary rider's foot (120), the footboard (130), and the brake assembly (140) on a traditional assembly. The positioning of the traditional brake assembly (140) forces an uncomfortable leg position and encourages riders to place their feet (120) under the brake pad (148). Placing a foot (120) under the brake pad (148) inhibits rapid deceleration that may be required during an emergency. Particularly, when riders (100) have a need to rapidly decelerate, they must remove their feet (120) from underneath the brake pad (148) prior to actuating the brake pad (148) itself. This operation may take precious seconds when rapid deceleration to avoid a possible accident is needed

The traditional brake assembly (140) is positioned such that a brake lever (144) extends upwardly and terminates at a position nearly one-half the distance of the footboard (130) distally from the front end of the footboard. Likewise, the brake pad (148) attached to the end of the brake lever (144) is positioned several inches distally from the front end of the footboard (130).

The position of the brake lever (144) and brake pad (148) result in the rider's leg (105) being bent at the knee at an uncomfortable angle during extended travel. To alleviate some of the pressure placed on the knee in this position, riders (100) slide their feet (120) forward under the brake pad (148) as shown in FIG. 1B. However, when the rider (100) must use the brake assembly (140), the foot (120) must be pulled out from under the brake pad (148). Typically this is accomplished by pulling the foot (120) rearward as shown in FIG. 1C. Once the foot (120) has been moved sufficiently rearward to enable it to be lifted above the brake pad (148), the foot (120) is moved into position on top of the brake pad (148) as shown in FIG. 1D. The rider (100) then pushes downwardly on the brake pad (148) as indicated by arrow (150). The downward force causes the brake lever (144) to rotate about a pivot point (160), triggering the braking mechanism that actuates the brake attached to the wheel.

In order to move the foot (120) into the proper position for braking, the rider (100) must move the foot rearward, lift the foot, move the foot forward onto the brake pad (148) and push down, as shown in FIGS. 1B through 1D. Alternatively, the rider (100) may slide the foot (120) laterally outward past the brake pad, lift the foot, move the foot inwardly until it is positioned over the brake pad and push down. Both methods result in foot and leg fatigue if performed often. Leg and foot fatigue dramatically increase reaction times during emergencies. The time required to maneuver a foot into the braking position, especially when fatigued, results in potentially unsafe braking conditions during emergency situations. Additionally, the movement path along which the brake pad (148) follows is somewhat awkward for many riders (100). That is, the movement of the foot (120) required to actuate the brake via the brake pad (148) is more of a downward movement than a forward movement. When the rider's leg (105) is bent, less force can be exerted in a downward direction, than can be than can be exerted in a forward direction.

After the brake has been applied and released, the rider must go through a reverse series of movements to return the foot (120) to the original, comfortable position located between the brake pad (148) and the foot board (130). When repeated braking is required, like in city driving, for example, the process can become both annoying and tiresome.

Consequently, there is a need for a brake actuation assembly for use with footboards that enables riders to comfortably actuate the brakes, does not cause fatigue when used frequently, and improves reaction time in emergency situations. Such a brake assembly should be simple to install and not interfere with other aspects of the motorcycle's operation.

Other solutions to this problem have been proposed, all of which required the use of a brake lever assembly independent from the footboard. These proposed solutions fail to resolve the problem of increased braking reaction times and driver fatigue due to the required lower leg, ankle, and foot movements to actuate the braking lever.

### SUMMARY

The present exemplary system and method provides a brake assembly integrated with a footboard for use on motorcycles. The present apparatus does not involve excessive movement of the lower leg, thereby decreasing the braking reaction time as compared with the prior art. The present exemplary apparatus and method also provide a more ergonomic and safe brake actuation system for motorcycles utilizing footboards.

The above advantages are realized by incorporating the brake actuation into the footboard itself. As will be explained in detail below, a motorcycle operator (a rider) can use the footboard to rest his/her foot while driving, and to actuate the brake the operator need only pivot the footboard. Such an apparatus eliminates all extraneous motion that is traditionally required of a rider using a system with a separate brake lever assembly.

According to one exemplary embodiment, the rear brake actuation takes place with the right foot. According to alternative embodiments, the present system and method is configured for use with either the right or the left foot of the rider.

A footboard of any size or shape and of varying materials is configured for use on any number of motorcycles. According to one exemplary embodiment, the footboard and braking assembly of the present apparatus and method are adapted for replacing existing brake assemblies, both those with footboards and those with foot pegs. According to one exemplary embodiment of the present system and method, a footboard is pivotably connected to a brake mechanism and when actuated causes the rear brake to be applied.

According to one exemplary embodiment, a pivot pin allows the present system and method to be universally installed on a wide variety of motorcycles. Specifically, a brake actuator configured with a first orifice to mate with the pivot pin and a second orifice to interact with a motorcycle's existing brake mechanism allows for a universal connection between the apparatus and a variety of brake mechanisms.

### BRIEF DESCRIPTION OF THE DRAWINGS

The accompanying drawings illustrate various embodiments of the present system and method and are a part of the specification. The illustrated embodiments are merely examples of the present apparatus and method and do not limit the scope thereof.

FIG. 1A illustrates a side view of a person riding a motorcycle having a footboard and braking assembly according to the prior art.

FIGS. 1B-1D illustrate close-up views of the footboard and actions needed to apply the brake, according to prior art embodiments.

FIG. 2 shows a side view of a prior art footboard and brake prior to its replacement by the present footboard and brake apparatus, according to one exemplary embodiment.

FIG. 3 illustrates a close-up view of an installed footboard and braking apparatus of the present system and method, according to one exemplary embodiment.

FIG. 4 illustrates a close-up view of the footboard and braking apparatus in motion, demonstrating how the brake is applied, according to one exemplary embodiment.

FIG. 5 illustrates a front view of a footboard and brake support structure, according to one exemplary embodiment.

FIG. 6 illustrates a perspective view of a footboard/brake support structure according to one exemplary embodiment.

FIG. 7A illustrates a perspective view of the actuator support and connecting pin, according to one exemplary embodiment.

FIG. 7B illustrates a side and partial internal view of an actuator support and connecting pin, according to one exemplary embodiment.

FIG. 8 is a flow chart illustrating a method of installing and using the present system and method, according to one exemplary embodiment.

Throughout the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION

A brake actuator assembly is disclosed herein that provides increased ergonomic function to the driver, faster reaction time during emergency braking, and an easier braking operation. An apparatus, combining the footboard and brake lever into a single configuration includes, according to one exemplary embodiment, a footboard resting on a supporting structure capable of rotation, a supporting pin allowing rotation, and a brake actuator incorporated into the assembly. According to one exemplary embodiment, the brake actuator is compatible with braking systems commonly found on existing motorcycles. Consequently, according to one exemplary embodiment, traditional footboard and peg assemblies can be replaced by the footboard and brake assembly disclosed herein will little or no modification to the brake system itself.

In the following description, for purposes of explanation, numerous specific details are set forth in order to provide a thorough understanding of the present apparatus and method. However, it will be apparent to one skilled in the art that the present method and system may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Unless the context requires otherwise, throughout the specification and claims which follow, the word “comprise” and variations thereof, such as, “comprises” and “comprising” are to be construed in an open, inclusive sense, that is as “including, but not limited to.”

The following description is presented to illustrate and describe several embodiments of the present exemplary system and method; it is not intended to limit the system and method to any exact form disclosed in conjunction with the various embodiments.

As will be seen below, the present exemplary system is described in detail, including the support mechanism, pins, and actuators, according to several exemplary embodiments. Then, the method of use is contrasted to that of the prior art, delineating several advantages.

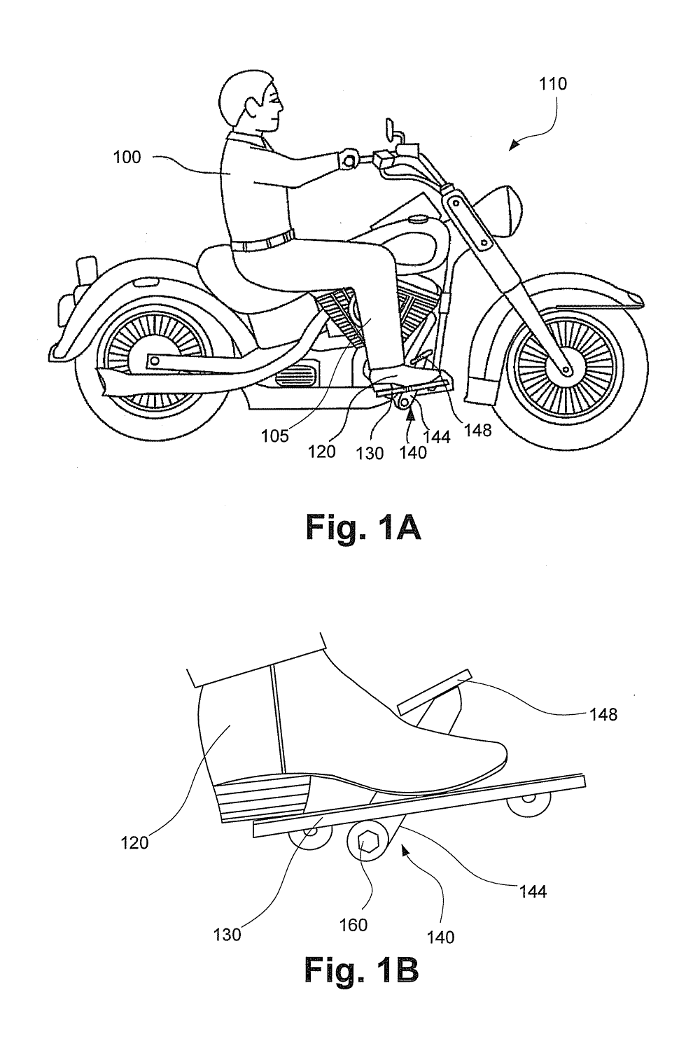

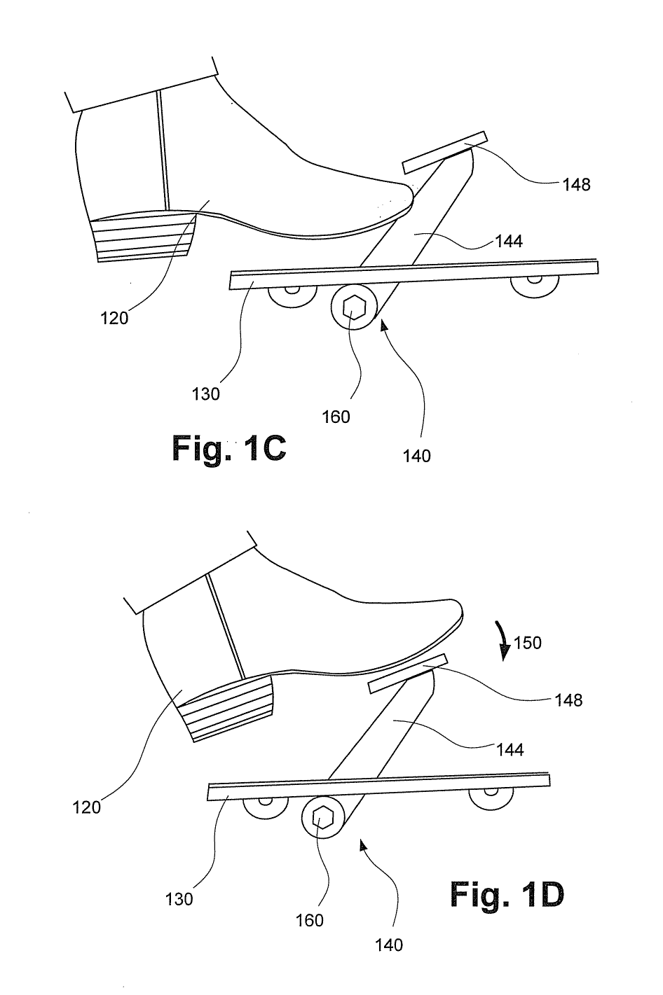

To fully understand the use and application of the present apparatus and method over traditional braking systems, an understanding of traditional footboard and brake assemblies is provided. Referring to FIG. 1A, a rider (100) is shown on a motorcycle (110) having a footboard (130) and traditional brake assembly (140). FIG. 1B illustrates in detail traditional brake assemblies (140) used in conjunction with footboards (130), according to various embodiments. The brake lever assembly (140) typically includes a pivot point (160) configured to actuate an internal brake mechanism when rotated, a brake lever (144) extending upwards at an angle, and a brake pad (148) for the rider to engage the lever. The angle and the length of the traditional brake lever (144) positions the brake pad (148) at an inconvenient location relative to the rider's foot (120). More specifically, when the traditional braking system is attached to a motorcycle (110), the brake lever (144) generally extends upward at an angle between about 40 and 55 degrees relative to the footboard (130). This angle places the brake pad (148) near the middle of the footboard (130). With the brake pad (148) in this position the rider typically positions the right foot (120) directly under the brake pad (148), resulting in the disadvantages discussed above, including a slow reaction time and general discomfort.

FIG. 1B illustrates a rider's foot (120) under a brake pad (148) as is common with traditional braking systems. For the rider (100) to actuate the brake, the foot (120) must be pulled out from under the brake pad (148; FIG. 1C), and then positioned on top of the brake pad (148) (See FIG. 1D). The expended time and muscle movements required for repositioning the rider's foot (120) prior to braking result in slower reaction times and muscle fatigue.

### Exemplary Embodiments

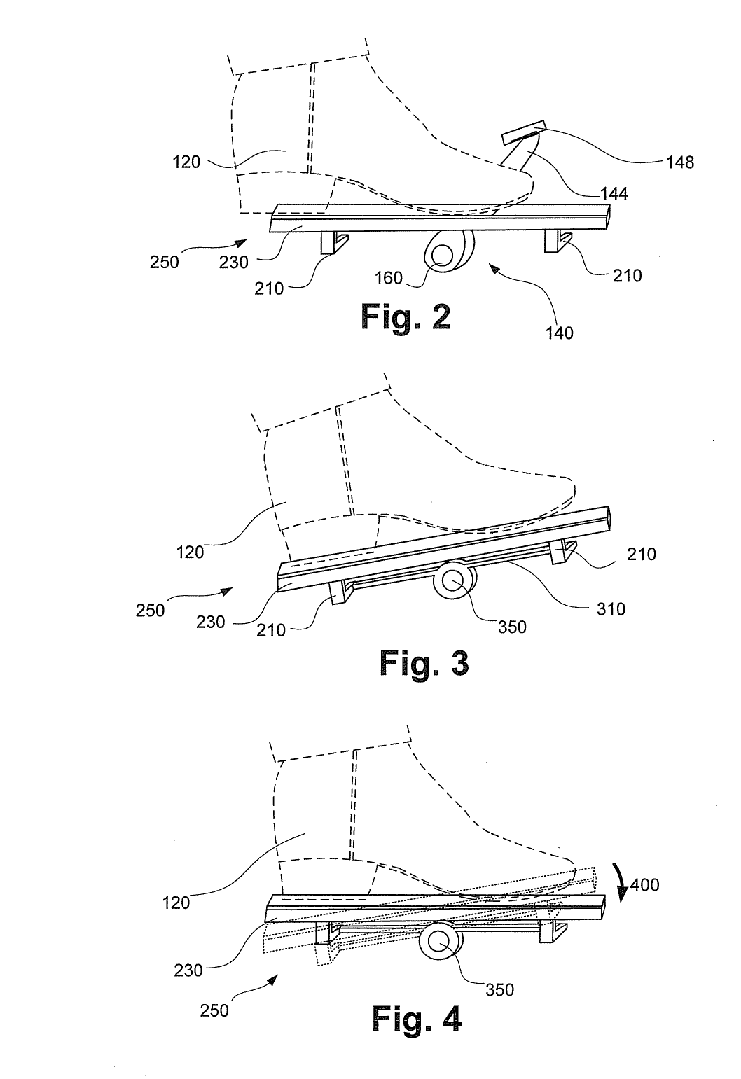

FIG. 2 illustrates a foot (120), footboard (250), and braking assembly (140) similar to those previously illustrated in FIGS. 1A-1D. In contrast, FIGS. 3 and 4 illustrate the incorporation of the presently disclosed apparatus, a combination footboard and brake assembly, according to one exemplary embodiment. As illustrated in FIG. 2, the traditional footboard (250) of FIG. 2 includes a platform (230) and support bars (210). The purpose of the platform (230) is to provide a rider with an adequate location to rest a right foot (120) during operation of a motorcycle (110, FIG. 1).

The platform (230) may be of various sizes and shapes. Particularly, various manufactures of footboards (250) and motorcycles may choose styles, patterns, and grip surfaces that correlate will with the overall style of the rider or motorcycle. Any of a variety of footboards (250) may be used with the present exemplary system and method. Typically, footboards (250) are secured to the motorcycle via one or more support bars (210) that are securely coupled to the frame of the motorcycle. Despite this traditional support system for footboards, the present system may be adapted for use with any number of footboards utilizing various support bar configurations described in further detail below.

Continuing with FIG. 2, a traditional footboard (250) is used in conjunction with a braking assembly (140). The braking assembly (140), as has been previously described, includes an actuating pivot point (160), a brake lever (144), and a brake pad (148). According to one exemplary embodiment of the present system and method, the combination footboard and brake system apparatus is configured to replace the traditional brake assembly (140) entirely while utilizing the original footboard (250) to conserve the look and feel of the motorcycle. Accordingly, as illustrated in FIG. 3, the traditional brake assembly (140) is completely removed, and the platform (230), through a number of support bars (210), rests entirely on a pivot support actuator (350). To accomplish this, the pivot support actuator (350) replaces the traditional pivot point (160, FIG. 2) associated with the traditional brake lever (144) and brake pad (148), which are obsolete in the present exemplary system. As illustrated in FIG. 3, the support bars (210) that previously secured the platform (230) directly to the motorcycle frame are used in the present exemplary system and method to both support the platform (230) and to securely yet rotatably couple the platform to the pivot support actuator (350).

Similar to the traditional pivot point (160) associated with a traditional brake lever (144) and brake pad (148), the pivot support actuator (350) of the present exemplary system and method is configured to actuate a braking system when rotated. Specifically, when a sufficient force is exerted on the platform (230) and the pivot support actuator (350) is rotated, the pivot support actuator, via internal connections to the existing brake system, will actuate the brake mechanism proportional with the actuating force exerted on the platform (230). As illustrated in FIG. 3, the present exemplary apparatus provides that the footboard (250), connected to the pivot support actuator (350), is pivotably rotatable. By pivoting the footboard (250) forward, the pivot support actuator (350) is rotated and the internal brake mechanism is actuated. Conversely, when the actuation force is released from the footboard (250) by a rider placing their foot in a traditional riding location, the pivot support actuator (350) disengages the internal brake mechanism (not shown) and the braking force is removed.

Referring to the traditional system illustrated in FIG. 2, it should be again noted that the rider is required to move the entire lower leg (105) or at least lift up the front portion of the foot (120) off of the footboard (250) rotating the ankle to apply pressure to the traditional brake pad (148). When pressure is applied, the brake lever (144) actuates the brake mechanism as the movement of the lever (144) causes rotation about the pivot point (160).

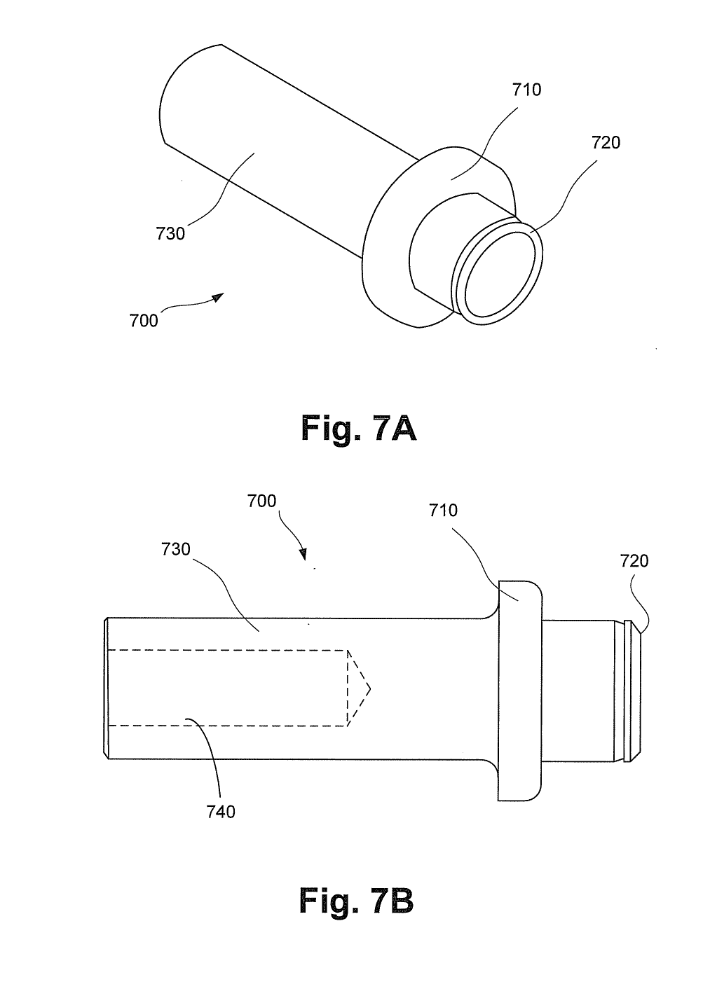

In contrast, the present configuration of the exemplary system and method illustrated in FIGS. 3 and 4 eliminates much of the movement required by the traditional brake lever configuration. Particularly, the elimination of the superfluous motion is accomplished by combining the brake lever assembly into the footboard assembly, both physically and functionally. According to one exemplary embodiment as shown in FIG. 3, the footboard (250) rests entirely on the pivot support actuator (350) and the related support bars (210) which are directly tied to the pivot support actuator, according to one exemplary embodiment. The pivot support actuator (350) is supported by and configured to rotate about a pivot support pin (700, FIG. 7A), described in detail below.

Turning to FIG. 4, brake actuation may be accomplished using the present exemplary system and method in one fluid motion, as illustrated in FIG. 4. Specifically, as shown in FIG. 4, no repositioning movement of the leg, ankle, or foot is required to actuate the brake. Rather, by using the calf muscle and ankle, the rider can impart a force on the forward section of the platform (230) portion of the footboard (250). The application of an actuation force on the forward portion of the footboard (250) rotates the footboard (250) about the pivot support actuator (350), causing the pivot support actuator to rotate and actuate the internal brake mechanism. The effect of the rotation of the pivot support actuator (350) is an actuation of the motorcycle's brake in a manner similar to traditional brake lever assemblies (140), namely, by a rotational force Imparted on a brake actuator (not shown). Consequently, installation of the presently disclosed system and method requires no modification of the existing internal brake mechanism.

According to alternative embodiments, the combined footboard and brake apparatus incorporates a footboard as an integral part of the apparatus. That is, rather than utilizing the original footboard (250), a new footboard is provided that forms an integral part of the brake actuation apparatus. According to one exemplary embodiment where the original footboard is not utilized, the present exemplary footboard configuration (FIG. 3) may be manufactured with a raised portion located on the front of the platform (230). According to this exemplary embodiment, the raise portion located on the front of platform (230) is between approximately 17-19 degrees; however one of skill in the art will appreciate that a raise of between 5 and 45 degrees or more may be used. That is, other appropriate angles may be used achieving the same convenience in braking. This may be particularly useful depending upon the configuration of the motorcycle. The raised portion located on the front of the platform (230) allows for easier actuation of the brake as the driver uses his ankle and calf muscles to rotate the brake assembly. An operator can impart a greater force onto the front of the assembly with the presence of a slight raise in the front of the assembly. Consequently, comfort is increased, ease of operation is increased, and faster reaction times are facilitated. Furthermore, in contrast to a completely planar footboard application, the inclusion of a raised portion of the platform (230) provides a noticeable change in the surface of the platform that a motorcycle operator can detect with his/her foot, to identify where on the platform they are located. Consequently, unintentional braking will be reduced and foot location can be established without the vehicle operator having to remove his/her gaze from the road they are traveling.

Additionally, many shapes, sizes, styles, and grip surfaces may be utilized in conjunction with the preset exemplary apparatus. According to various embodiments, the original footboard of the motorcycle can be reused. Alternatively, the apparatus may include a modified footboard as an integral part of the overall braking apparatus.

In addition, the physical position of the footboard (250) relative to the ground may be higher or lower when compared to the placement of traditional footboards. Specifically, according to one exemplary embodiment, a higher vertical position of the footboard (250) relative to the ground may be incorporated to provide increased ground clearance of the footboard (250) from the ground when cornering, thereby decreasing the likelihood of unintentional brake actuation. In fact, various modifications are possible offsetting the pivoting footboard as compared to the prior location of the footboard in any direction desired. This offers the rider the option to position the modified pivotable footboard in nearly any location.

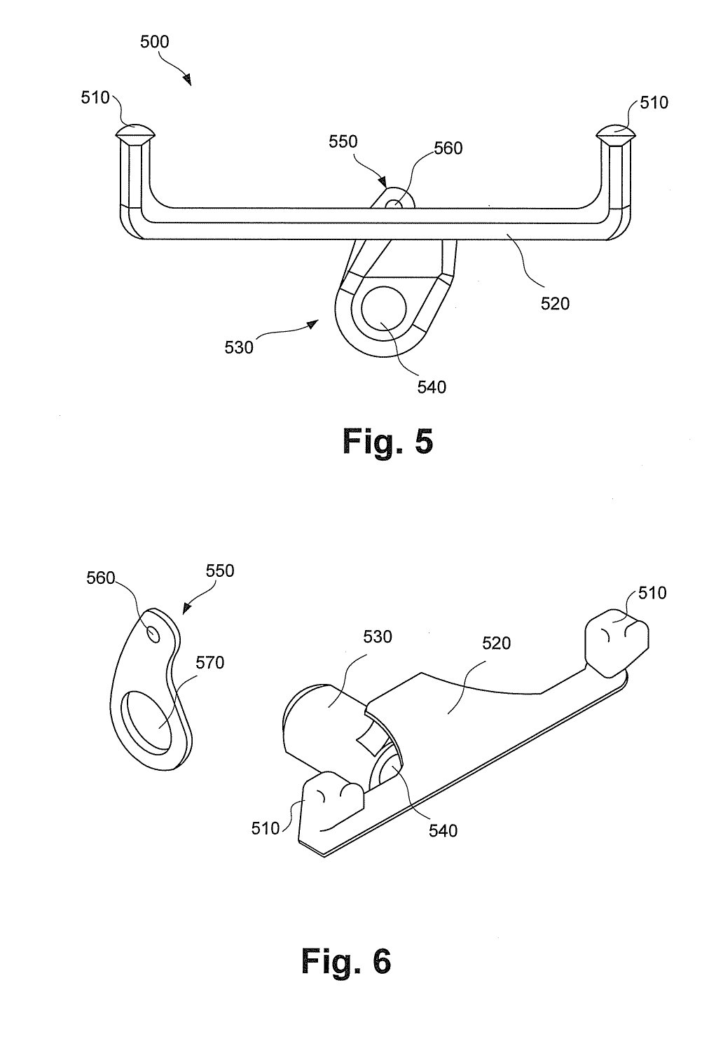

As mentioned above, according to one exemplary embodiment, the footboard (250) portion of the present exemplary brake actuation system pivots about the pivot support actuator. FIGS. 5 and 6 illustrate a supporting brake actuation structure (500) in its entirety, according to one exemplary embodiment. According to the exemplary embodiment illustrated in FIGS. 5 and 6, the brake actuation structure (500) includes a brake actuator (550), a pivot cylinder (530), a footboard support structure (520), footboard support arms (510), and a pivot-pin hole (540). The entire structure (500) may be manufactured using any acceptable method known to one skilled in the art and may be constructed of steel, aluminum, composites, or any other appropriate metal, plastic, a combination thereof, or other suitable materials.

According to one exemplary embodiment of the present supporting brake actuation structure (500), the footboard support arms (510) extend from the footboard support structure (520) and provide connection to and support for a conventional footboard (250, FIG. 4). A general depiction of a connection member is illustrated in FIGS. 5 and 6. Any number of connection and/or fastening means may be used to couple the present supporting brake actuation structure (500) to a footboard (250). Various methods to secure a footboard (250) to the structure (500) are possible, including, but not limited to, screws, bolts, tabs, glues, snaps, welds, and other alternative fastening means. Consequently, the support arms (510) may be modified as necessary to accommodate the fastener and footboard used. Furthermore, according to one exemplary embodiment, the footboard (250) may be formed as an integral part of the supporting brake actuation structure (500).

According to one exemplary embodiment, the support arms (510) are manufactured as an integral part of the footboard support structure (520). Alternatively, the support arms (510) may be manufactured separate and thereafter fastened to the support structure (520). Regardless, the support arms (510) and the support structure (520) provide an element of rigidity and linkage from the footboard (250, FIG. 4) through the support arms (510) to the pivot cylinder (530), which is a part of the footboard support structure (500).

According to one exemplary embodiment, the pivot cylinder (530) is positioned slightly in front of the midpoint of the support arms (510). According to this exemplary embodiment, the relative position of the pivot cylinder (530) prevents accidental actuation of the brake system by requiring at least a predefined amount of force to actuate the brake mechanism. According to the illustrated embodiment, the pivot cylinder (530) is free to rotate about a pivot support pin (700, FIG. 7A); the pivot support pin is described in detail in conjunction with FIGS. 7A and 7B below. This freedom of rotation allows the rider to rotate the brake assembly by simply pushing on the front portion of the footboard (250, FIG. 4), which rotation will rotate the brake actuator (550).

According to one exemplary embodiment, the present brake actuator (550) may be manufactured separately and then assembled to the brake actuation structure (500) as shown in FIG. 6 or it may be manufactured as a single element, as illustrated in FIG. 5. Whether manufactured separately or as a single element, the brake actuator (550) performs the same function. That is, the brake actuator (550) is compatible with existing motorcycle brake systems. Specifically, the actuator (550) allows the present system and method to replace an existing brake assembly on any motorcycle utilizing the standard internal brake mechanism. According to one exemplary embodiment, the braking system referred to in the present exemplary embodiment is actuated just above the location of the traditional brake lever. In the case of the present exemplary configuration, the actuation of the braking system is performed just above the pivot point (160, FIG. 1B-1D) of the brake assembly (140, FIG. 1B). As illustrated in FIGS. 5 and 6, two orifices (560, 570) are defined by the brake actuator (550). The orifices (560, 570) are configured to provide mating compatibility with the aforementioned traditional brake system. The pivot-pin hole (570) allows rotation about the pivot support pin (700, FIG. 7A) while the brake actuator connection hole (560) provides compatibility with present motorcycle brake systems.

According to one exemplary embodiment, the exemplary pivot support pin (700) illustrated in FIGS. 7A and 7B may be manufactured by any acceptable method known to one skilled in the art including, but in no way limited to, casting, turning, and the like. Furthermore, the present exemplary pivot support pin (700) may be made of, but is in no way limited to, steel, aluminum, titanium, composites, plastics, other metals, or any appropriate combination thereof.

The illustrated exemplary pivot support pin (700) is configured for compatibility with existing brake systems on current motorcycles. According to one embodiment, the pivot support pin is manufactured with appropriate connections (720) according to the make and model of the motorcycle on which it is to be installed. The present exemplary embodiment shows the connection (720) including two adjacent machined angles allowing a quick fastening of the pin (700) to the motorcycle. The chamfered edge of the pin (720) allows insertion of the pin (700) while locking the pin (700) in place after insertion. Alternative configurations are foreseen and expected as necessary to accommodate the make and model of motorcycle. Variations regarding the method and manner of installing the pin (700) will depend largely upon the manufacturing of the motorcycle itself. The embodiment illustrated in FIGS. 7A and 7B is according to one exemplary embodiment.

The brake assembly, including the support structure (500), is positioned relative to the other parts of the motorcycle by a boundary protrusion (710). Specifically, the footboard braking structure (500) is secured to and rests on the brake actuator support cylinder (730). According to traditional systems, the support cylinder (730) is much shorter as it only supports the brake assembly (140, FIG. 1B-1D) and does not support the footboard (520). The supporting cylinder (730) of the presently described apparatus is longer than traditional actuation cylinders in order to support the braking assembly (500) and footboard (250). This increased length and size enhances strength while allowing the cylinder (730) to withstand the forces and torques applied by the combination brake (500) and footboard (250) apparatus.

The freedom of rotation between the brake actuator (550) and support structure (500) and pivot support pin (500) may be accomplished by any acceptable means known to one skilled in the art. It may include but is in no way limited to bearings, lubricants, or other acceptable joints or combinations thereof.

While the present exemplary system has been described and illustrated as using a single specific brake assembly and corresponding supporting cylinder, the teachings of the present exemplary system and method may be modified to correlate with various motorcycle types, sizes, and configurations.

In general, the present exemplary system and method provides for an integrated footboard and braking system. Providing an apparatus functioning as both a footboard and brake actuator, both the comfort of the rider's foot and the effectiveness of the braking mechanism are enhanced. Further, the combination footboard and brake actuation member provides better reaction time when braking is required. Furthermore, the present exemplary system and method includes a number of incorporated safety features including, but in no way limited to, increased angle and positioning of the footboard and added strength to the supporting actuation cylinder. Additionally, according to several embodiments, it offers the rider the opportunity to modify the height or position of the footboard as compared to the original footboard and brake lever position.

While the present system and method has been described exclusively for use with a motorcycle having a brake actuated by a rider's right foot, adaptations for use on the left side are possible. Additionally, while the present system and method have been described for use with a motorcycle, the combination footboard and brake may also be used with three-wheelers, four-wheelers, cars, go-carts, and any other type of all-terrain vehicle or vehicle in general. The specific details may be easily adapted for incorporation into a wide variety of vehicles utilizing a foot brake. If fact, the footboard/actuator might be used to actuate and/or control alternative devices as well, including but not limited to, the clutch, the acceleration, the brakes, and other mechanically actuated devices.

### Method of Use

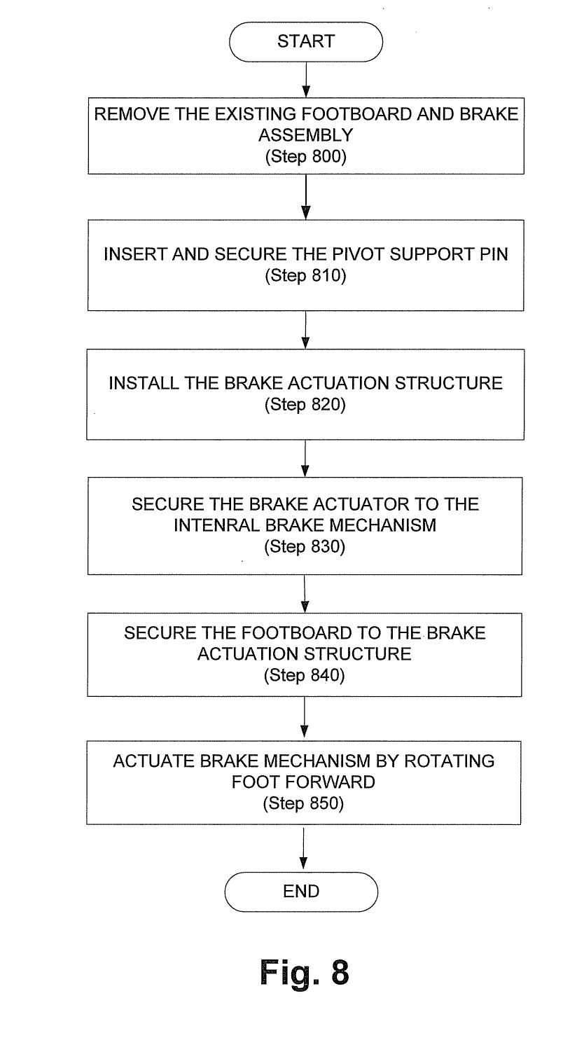

FIG. 8 provides a flow chart illustrating a process of replacing an existing footboard and brake assembly with the combination footboard and brake apparatus of the present system and method, according to one exemplary embodiment. Where the replacement footboard and brake combination requires only that the footboard be pivotally rotated to actuate the brake mechanism of a motorcycle. The advantages of the combination footboard and brake over the traditional footboard and separate brake lever are detailed above.

After removing the initial footboard (250, FIG. 2) and brake assembly (140, FIG. 2)(Step 800, FIG. 8), a pivot support pin (700, FIG. 7A) is inserted to replace the existing pin (Step 810). According to one exemplary embodiment, the pivot support pin (700) is longer and stronger than original support pins. The added length and strength provide the necessary support for strains induced by the pivotable footboard. According to various embodiments, the pivot support pin (700) is an integral part of the brake actuation structure (500, FIG. 5). Accordingly, Steps 810 and 820 can be combined into one step. However, according to various embodiments, the brake actuation structure (500) is a separate part and is installed subsequent to the pivot support pin (700)(Step 820).

The brake actuator (550, FIG. 5) is an integral part of the assembly. It must be installed when necessary depending upon the make and model of the motorcycle. Should it need be installed prior to Step 830 it may. The brake actuator (550) should be secured to the internal brake mechanism via the small orifice (560). The larger office (570) allows the brake actuation structure (500) to pivot about the pivot pin (700, FIG. 7A). Once the brake actuator (550) is installed and connected to the internal brake mechanism (Step 830), the footboard (250, FIG. 2) may be secured to the footboard support arms (510)(Step 840).

According to various embodiments, the footboard may be an integral part of the brake actuator support. Consequently, it would be installed simultaneously in Step 820. According to one exemplary embodiment, the footboard (250) used is the same footboard (250) that was removed in Step 800. Alternative embodiments utilize a footboard specifically designed for the apparatus. Such a footboard may be included with the assembly. Various methods to secure a footboard to the footboard support arms (510) are possible. The methods used may depend upon the make and model of footboard and/or motorcycle.

Once the combination footboard and brake apparatus is fully installed, a rider need only rotate the right foot forward to actuate the internal brake mechanism. The slight forward rotation will cause the footboard (250) to pivot about the pivot cylinder (530) causing the brake actuator (550) to rotate, thereby actuating the internal brake mechanism (Step 850).

The preceding description provides a method of securing the combination footboard and brake apparatus to a motorcycle, according to one exemplary embodiment. The steps delineated in FIG. 8 may be performed in the order described above; however, the same results may be achieved by performing the steps in an alternative order, so long as it results the brake actuator (550) being connected to the internal brake mechanisms and actuated by the footboard being pivoted. The order of Steps described need not necessarily be strictly adhered to. For example it may be possible to secure the footboard (250) to the brake actuator support (500) as a first step.

The preceding description has been presented only to illustrate and describe the present method and system. It is not intended to be exhaustive or to limit the present system and method to any precise form disclosed. Many modifications and variations are possible in light of the above teaching.

The foregoing embodiments were chosen and described in order to illustrate principles of the system and method as well as some practical applications. The preceding description enables others skilled in the art to utilize the method and system in various embodiments and with various modifications, as are suited to the particular use contemplated. It is intended that the scope of the present exemplary system and method be defined by the following claims.

What is claimed is:

1. A mechanical actuation assembly comprising
a footboard; and
an actuation member;
wherein said footboard and said actuation member are pivotally coupled.

2. The mechanical actuation assembly of claim 1, wherein said actuation assembly is configured to actuate a brake.

3. The mechanical actuation assembly of claim 2, wherein said actuation assembly is configured to actuate a mechanical member by a rotation of said footboard about said actuation member.

4. The mechanical actuation assembly of claim 3, wherein said footboard is positioned at an inclined angle when in an unactuated state.

5. The mechanical actuation assembly of claim 4, wherein said inclined angle is between 17-19 degrees relative to horizontal.

6. The mechanical actuation assembly of claim 4, wherein said inclined angle is between 5 and 43 degrees relative to horizontal.

7. The mechanical actuation assembly of claim 2, wherein said actuation member comprises:
a brake actuator;
a pivot cylinder;
a footboard support member;
a pivot pin hole; and
a pivot pin.

8. The mechanical actuation assembly of claim 7, wherein said actuation member is configured to replace an existing brake pivot, brake lever, and brake pad of a motorcycle.

9. The mechanical actuation assembly of claim 8, wherein when said footboard is pivotably rotated about said actuation member, said brake actuator is rotated causing said brake actuator to actuate said brake of said motorcycle.

10. A brake actuation assembly comprising;
a footboard;
a brake actuation member; and
a pivot pin;
wherein said footboard is pivotally coupled to said brake actuation member.

11. The brake actuation assembly of claim 10, wherein said footboard actuates said brake actuation member by pivoting said footboard about said brake actuation member.

12. The brake actuation assembly of claim 11, wherein said footboard is positioned at an inclined angle when in an unactuated state.

13. The brake actuation assembly of claim 11, wherein said brake actuation member comprises:
a brake actuator;
a pivot cylinder;
a footboard support member; and
footboard support arms.

14. The brake actuation assembly of claim 13, wherein said footboard is secured to said footboard support member via said footboard support arms and said brake actuation assembly is configured for use on a motorcycle.

15. The brake actuation assembly of claim 14, wherein said footboard and said footboard support member pivot about said pivot cylinder; and when said footboard is pivoted, said brake actuator is actuated causing a brake of said motorcycle to be applied.

16. A footboard and brake combination apparatus configured to replace both the footrest and lever brake assembly of a motorcycle comprising:
a brake actuator;
a pivot cylinder;
a footboard support member; and
a pivot pin;
wherein said footboard support member is pivotally connected to said pivot cylinder.

17. The apparatus of claim 16, wherein said pivot pin is configured for universal installation in any motorcycle following the removal of said footrest and lever brake assembly of said motorcycle.

18. The apparatus of claim 17, wherein said brake actuator is configured to pivotably couple said apparatus to an internal brake mechanism of said motorcycle such that when said footboard support member is pivoted relative to said pivot pin, said internal brake mechanism is actuated.

19. The apparatus of claim 18, wherein said pivot cylinder is fixedly connected to said footboard support member; said pivot cylinder being configured to pivot about said pivot pin.

20. The apparatus of claim 19, wherein said apparatus further comprises a footboard; wherein said footboard is positioned at an inclined angle when in an unactuated state.
